(19) United States
(12) Patent Application Publication
(10) Pub. No.: US 2024/0399754 A1
(43) Pub. Date: Dec. 5, 2024

(54) CONTROLLING APPARATUS, CONTROL METHOD OF CONTROLLING APPARATUS, AND STORAGE MEDIUM

(71) Applicant: CANON KABUSHIKI KAISHA, Tokyo (JP)

(72) Inventor: TAKETOSHI KUSAKABE, Kanagawa (JP)

(21) Appl. No.: 18/633,910

(22) Filed: Apr. 12, 2024

(30) Foreign Application Priority Data
May 31, 2023 (JP) 2023-089957

(51) Int. Cl. B41J 2/175

(52) U.S. Cl. CPC B41J 2/17566

(57) ABSTRACT

A controlling apparatus controlling apparatus which includes a buffer tank configured to supply a liquid, which contains a sedimentation component, to a print head device and a replacement tank configured to supply the liquid to the buffer tank, and is configured to control a printing apparatus capable of performing printing by using the liquid, includes: one or more processors and/or circuitry which function as: an obtaining unit configured to obtain liquid remaining amounts of the replacement tank of the liquid and the buffer tank of the liquid; and a notification unit configured to notify content that replacement of the replacement tank is possible in a case where the replacement tank of the liquid is empty and the buffer tank of the liquid has a free space equal to one replacement tank of the liquid or more.

### BACKGROUND OF THE INVENTION

### Field of the Invention

The present disclosure relates to control of replacement of liquid tanks in a printing apparatus.

### Description of the Related Art

There is known a configuration of a printing apparatus that includes plural stages of liquid tanks such as a replacement tank for replacement and a buffer tank installed in the printing apparatus to supply a liquid to a print head unit. Employing a configuration in which the liquid is constantly supplied from the buffer tank to the print head unit by replacing an empty replacement tank with a new replacement tank in a case where the replacement tank becomes empty can achieve continuous printing. There is also known a technique of displaying individual liquid remaining amounts of the buffer tank and the replacement tank in this case. For example, Japanese Patent Laid-Open No. 2022-087200 discloses a technique in which, in a printing apparatus including two containers such as a main tank and a sub-tank, an individual remaining amount state of each tank or a remaining amount state corresponding to a total amount in both tanks is displayed in a liquid remaining amount screen and other screens.

### SUMMARY OF THE INVENTION

A controlling apparatus according to the present disclosure is a controlling apparatus controlling apparatus which includes a buffer tank configured to supply a liquid, which contains a sedimentation component, to a print head device and a replacement tank configured to supply the liquid to the buffer tank, and is configured to control a printing apparatus capable of performing printing by using the liquid, includes: one or more processors and/or circuitry which function as: an obtaining unit configured to obtain liquid remaining amounts of the replacement tank of the liquid and the buffer tank of the liquid; and a notification unit configured to notify content that replacement of the replacement tank is possible in a case where the replacement tank of the liquid is empty and the buffer tank of the liquid has a free space equal to one replacement tank of the liquid or more.

Further features of the present disclosure will become apparent from the following description of exemplary embodiments with reference to the attached drawings.

### BRIEF DESCRIPTION OF THE DRAWINGS

FIG. 1 is a diagram illustrating an apparatus configuration of a printing apparatus system;

FIG. 2 is a block diagram illustrating a functional configuration of the printing apparatus system;

FIG. 3 is a diagram illustrating a configuration of buffer tanks and replacement tanks;

FIG. 4 is a diagram illustrating a state of display of liquid remaining amounts on a UI;

FIG. 5 is a diagram illustrating a state of display of the liquid remaining amounts on the UI;

FIG. 6 is a diagram illustrating a state of display of the liquid remaining amounts on the UI;

FIG. 7 is a diagram illustrating a state of display of the liquid remaining amounts on the UI;

FIG. 8 is a diagram illustrating a state of display of the liquid remaining amounts on the UI;

FIG. 9 is a flowchart illustrating control of liquid tank replacement notification; and

FIG. 10 is a diagram illustrating a state of display of the liquid remaining amounts on the UI.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

In this specification, the terms “print” and “printing” not only include the formation of significant information such as characters and graphics, but also broadly includes the formation of images, figures, patterns, and the like on a print medium, or the processing of the medium, regardless of whether they are significant or insignificant and whether they are so visualized as to be visually perceivable by humans. Also, the term “print medium (or sheet)” not only includes a paper sheet used in common printing apparatuses, but also broadly includes materials, such as cloth, a plastic film, a metal plate, glass, ceramics, wood, and leather, capable of accepting ink. Furthermore, the term “ink” (to be also referred to as a “liquid” hereinafter) should be broadly interpreted to be similar to the definition of “print” described above. That is, “ink” includes a liquid which, when applied onto a print medium, can form images, figures, patterns, and the like, can process the print medium, and can process ink. The process of ink includes, for example, solidifying or insolubilizing a coloring agent contained in ink applied to the print medium.

### First Embodiment

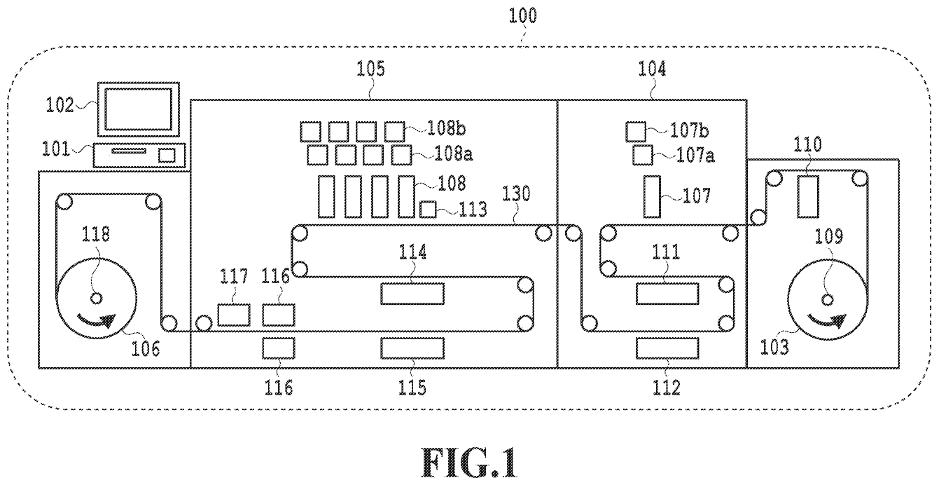

FIG. 1 is a diagram illustrating an example of an apparatus configuration of a printing apparatus system in the present embodiment. The printing apparatus system 100 (printing apparatus 100) is an apparatus configured to print an image on a continuous paper 130 (hereinafter, referred to as “roll paper”) that is used in the present embodiment and on which continuous printing is possible. The printing apparatus system 100 includes a control PC 101, an UI operation panel 102, a feeding unit 103 that conveys the roll paper 130, a first chamber 104 in which particular color printing is performed, a second chamber 105 in which basic color printing is performed, and a discharging unit 106 that winds up the roll paper 130. Note that, although the printing apparatus in the present embodiment is an inkjet printing apparatus, the printing apparatus may be an electrophotographic printing apparatus that uses liquids such as liquid toners.

The control PC 101 is a PC that performs various types of control of the printing apparatus system 100. The UI operation panel 102 is a mechanism that displays a state of the apparatus to notify the user of the state and that is for controlling the printing apparatus system 100 in response to operation instructions of the user. The UI operation panel 102 is connected to the control PC 101. The feeding unit 103 is an apparatus that supplies the roll paper 130 to the first chamber 104 and the second chamber 105. The feeding unit 103 rotates a paper tube of the roll paper 130 about a rotating shaft 109 and conveys the roll paper 130 wound around this paper tube to the first chamber 104 and the second chamber 105 via plural rollers such as conveyance rollers and feed rollers at constant velocity. The discharging unit 106 is an apparatus that winds up the roll paper 130 conveyed from the first chamber 104 and the second chamber 105 into a roll shape around a paper tube. The discharging unit 106 winds up the roll paper 130, conveyed to the paper tube by being rotated about a rotating shaft 118, around the rotating shaft 118 at constant velocity as a printed material of the roll paper 130 via plural rollers such as conveyance rollers and discharge rollers.

Before start of printing, the roll paper 130 is passed from the feeding unit 103 to the discharging unit 106. The roll paper 130 is set in the feeding unit 103, and a leading edge of the roll paper 130 is passed over a skew correction unit 110. Next, the roll paper 130 is passed below a first print head unit 107 (first print head device) in the first chamber 104. Then, the roll paper 130 is passed over a drying unit 111, and is passed over a cooling unit 112. The roll paper 130 is passed under a timing mark detection unit 113 in the second chamber 105, and is passed under second print head units 108 (second print head devices). Then, the roll paper 130 is passed over a drying unit 114, and is passed over a cooling unit 115. The roll paper 130 is passed through a scanner unit 116, is passed below a color measurement unit 117, and is conveyed to the discharging unit 106.

After the roll paper 130 is passed inside the printing apparatus system 100, a print job is inputted into the control PC 101 of the printing apparatus system 100. After the input of the print job, the printing is started in a case where a print start button is pressed in the UI operation panel 102. The first print head unit 107 and the second print head units 108 form an image by ejecting liquids (inks) to the roll paper 130. The liquid is supplied to the first print head unit 107 from a W buffer tank 107a. The liquid is supplied to the W buffer tank 107a from W replacement tanks 107b. The liquids are supplied to the second print head units 108 from buffer tanks 108a of the respective liquid colors. The liquids are supplied to the buffer tanks 108a from replacement tanks 108b. The user replaces the replacement tanks 107b and 108b to supply the liquids to the first print head unit 107 and the second print head units 108. Note that the user needs to open lids of corresponding portions to replace the replacement tanks 107b and 108b, and completes the replacement work by closing the lids after completion of tank replacement. The lids include lock mechanisms, and the control is performed such that the replacement cannot be executed in periods other than a timing at which the replacement is possible.

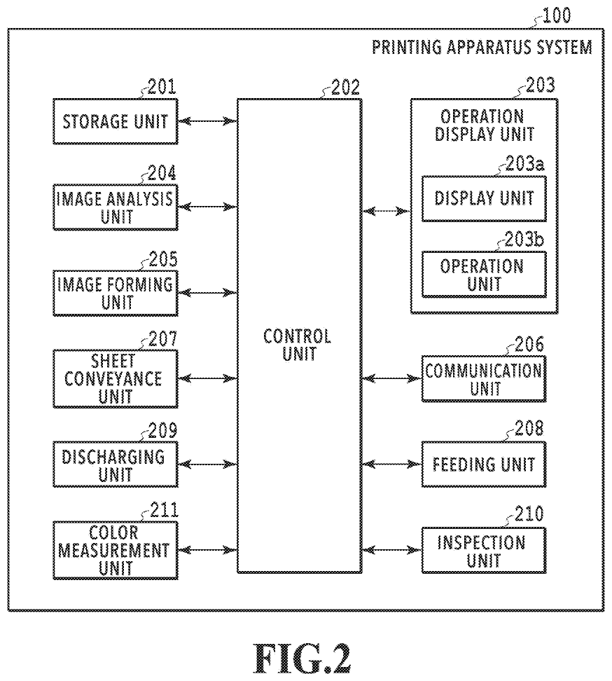

FIG. 2 is a block diagram illustrating an example of a functional configuration of the printing apparatus system 100 in the present embodiment. The printing apparatus system 100 includes a storage unit 201, a control unit 202, an operation display unit 203, an image analysis unit 204, an image forming unit 205, a communication unit 206, a sheet conveyance unit 207, a feeding unit 208, a discharging unit 209, an inspection unit 210, and a color measurement unit 211. Moreover, the printing apparatus system 100 also includes an audio unit 212 (not illustrated). The control unit 202 controls the storage unit 201, the operation display unit 203, the image analysis unit 204, the image forming unit 205, the communication unit 206, the sheet conveyance unit 207, the feeding unit 208, the discharging unit 209, the inspection unit 210, the color measurement unit 211, and the audio unit 212.

The storage unit 201 is formed of, for example, a non-volatile semiconductor memory (so-called flash memory), a hard disk drive (HDD), a solid state drive (SSD), or the like. Various programs such as a system program and a processing program that are executed in a CPU of the control unit 202 and various pieces of data necessary for execution of these programs are stored in the storage unit 201.

The control unit 202 is a control PC 101, and includes a central processing unit (CPU), a random access memory (RAM), and the like. The CPU of the control unit 202 reads various programs such as the system program and the processing program stored in the storage unit 201, loads the programs onto the RAM, and executes various processes according to the loaded programs. For example, the CPU of the control unit 202 can perform image forming processing of executing the print job (hereinafter, referred to as “job”) in response to an instruction of the user. Various functions forming the printing apparatus system 100 are controlled based on instructions of the CPU of the control unit 202.

The operation display unit 203 is formed, for example, a liquid crystal display (LCD) with a touch panel, and includes a display unit 203a and an operation unit 203b. The display unit 203a displays various pieces of information on a UI screen according to display control signals received from the CPU of the control unit 202. The operation unit 203b includes various operation keys such as numerical keypads and a start key, receives various input operations performed by the user, and outputs operation signals to the CPU of the control unit 202. The user can set any of conditions such as a paper sheet to be used, information on printing speed, the number of sheets to be printed, the number of copies to be printed, and a printing length as desired by performing user input from the operation unit 203b. The display unit 203a can display liquid remaining amounts of the buffer tanks 107a and 108a, a remaining amount of roll paper in the feeding unit 103, and a free space of roll paper in the discharging unit 106, and can also display whether replenishment work or the like is necessary or not. Specifically, the operation display unit 203 is implemented by the UI operation panel 102.

The image analysis unit 204 performs analyzing processing, rendering processing, and screen processing on print data for which an output instruction is received, and converts the print data to an output format printable in the printing apparatus system 100. The image forming unit 205 controls printing of an image onto the roll paper 130 through the first print head unit 107 and the second print head units 108. The communication unit 206 is formed of a communication control card such as, for example, a local area network (LAN) card. The communication unit 206 exchanges various pieces of data with an external apparatus (for example, a personal computer) connected to a communication network such as a LAN or a wide area network (WAN).

The sheet conveyance unit 207 controls a conveyance mechanism of the roll paper 130 inside the printing apparatus system 100. The sheet conveyance unit 207 conveys the roll paper 130, conveyed from the feeding unit 103, to the discharging unit 106 via the first print head unit 107 and the second print head units 108 by using plural rollers. The feeding unit 208 controls the feeding unit 103. The discharging unit 209 controls the discharging unit 106.

The inspection unit 210 controls the scanner unit 116 that checks whether printing on the roll paper 130 is performed without ejection failure. The inspection unit 210 reads a pattern for ejection failure inspection printed by the first print head unit 107 and the second print head units 108 by using the scanner unit 116 to check whether there is ejection failure in the printed image. In a case where the inspection unit 210 detects ejection failure, the CPU of the control unit 202 stops the printing apparatus system 100. The inspection method includes various methods such as a method of printing an inspection pattern and reading the inspection pattern with the scanner unit 116, a method of directly reading a printed image with a camera or a scanner and inspecting the printed image, and a method of monitoring a status of ejection from nozzles. The present embodiment employs a configuration in which the method of printing the inspection pattern and reading the inspection pattern with the scanner unit 116 is used to check whether there is ejection failure.

The color measurement unit 211 controls the color measurement unit 117, and obtains color information by measuring colors in a portion on the roll paper 130 specified by the CPU of the control unit 202. Note that the color measurement unit 117 is movable in a conveyance direction of the roll paper 130 and a direction orthogonal to the conveyance direction, and can measure colors not only in an image on the roll paper 130 but in any portion. Moreover, in order for the color measurement unit 117 to measure colors, a square region with a length of one centimeter or more in vertical and horizontal directions needs to be printed in the same color, as a region to be a color measurement target of the roll paper 130.

The audio unit 212 notifies the user of the content that the user needs to be notified, through audio. For example, in a case where replacement of the replacement tank becomes necessary, the audio unit 212 notifies the user that the replacement of the replacement tank is necessary, through audio.

Explanation is given of operations in a case where the image forming processing is performed on the roll paper 130 in the printing apparatus system 100. First, the user inputs the job. The user creates image data of the job in the external apparatus, performs print setting of the job, and transmits these pieces of information to the printing apparatus system 100 via the communication network. Next, the CPU of the control unit 202 of the printing apparatus system 100 receives a job ticket transmitted from the external apparatus via the communication unit 206, the job ticket including the image data of the job, the print setting information of the job, information on the number of delivered rolls, and the like. Then, the input of the job is completed. The image analysis unit 204 analyzes the inputted job. Specifically, the image analysis unit 204 extracts the information of the job ticket. Moreover, the image analysis unit 204 extracts pixel data from the image data, and decomposes the pixel data into liquid colors printable in the first print head unit 107 and the second print head units 108 for each pixel position such that a printed material reflecting the print setting is obtained.

In a case where printing of the inputted job is started, the roll paper 130 is conveyed along the path explained in FIG. 1, and the CPU of the control unit 202 prints a timing mark and a background in the first print head unit 107 through the image forming unit 205. The timing mark and the background printed on the roll paper 130 reach the timing mark detection unit 113 via the drying unit 111 and the cooling unit 112 with the conveyance of the roll paper 130. The CPU of the control unit 202 determines a start timing of printing on the roll paper 130 based on a timing of detection of the timing mark by the timing mark detection unit 113, and performs printing in the second print head units 108. In a case where the roll paper 130 subjected to printing reaches the scanner unit 116, the inspection unit 210 checks whether there is ejection failure as described above. In a case where the roll paper 130 subjected to printing reaches the color measurement unit 117, the color measurement unit 211 measures colors in the portion on the roll paper 130 specified by the CPU of the control unit 202 as described above.

Lastly, the roll paper 130 is conveyed along the path explained in FIG. 1, and is wound up by the discharging unit 106. The CPU of the control unit 202 controls liquid supply from the replacement tanks 107b and 108b to the first print head unit 107 and the second print head units 108, and controls the mechanisms relating to the replacement work of the replacement tanks 107b and 108b, and the UI screen.

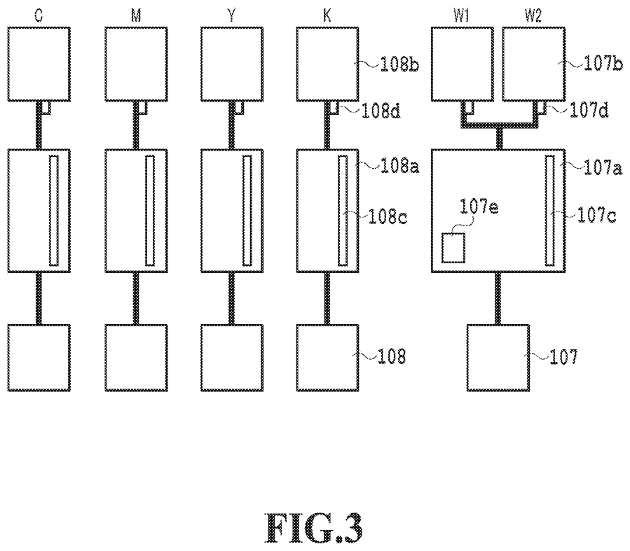

FIG. 3 is a diagram illustrating a configuration of the buffer tanks and the replacement tanks. The second print head units 108 are devices that eject colors of cyan, magenta, yellow, and black (hereinafter, referred to as “C, M, Y, K”) being liquids requiring no agitation, and are connected to the buffer tanks 108a of the respective colors. The liquids in the buffer tanks 108a are supplied to the second print head units 108, and the configuration is such that printing can be continued unless the liquid remaining amounts of the buffer tanks 108a become empty. The buffer tanks 108a are connected to the respective replacement tanks 108b, and the liquids inside the replacement tanks 108b are supplied to the buffer tanks 108a as necessary. Remaining amount sensors 108c are mounted in the buffer tanks 108a, and obtain the liquid remaining amounts of the buffer tanks. Remaining amount sensors 108d are mounted in the replacement tanks 108b, and obtain information on whether the liquids are left in the replacement tanks 108b. As described above, the liquids inside the replacement tanks 108b are supplied to the second print head units 108 via the buffer tanks 108a. The configuration is such that, in a case where the printing is continued, the liquid remaining amounts of the replacement tanks become empty first. The user replaces the empty replacement tanks 108b with unused replacement tanks 108b. Note that a liquid capacity of one replacement tank is 20% of a volume of liquid storable in the buffer tank. Note that this value is merely an example, and may be other values.

The first print head unit 107 is connected to the buffer tank 107a of white (hereinafter, referred to as “W buffer tank 107a”) that is a liquid requiring agitation and containing a sedimentation component. The W buffer tank 107a is connected to the W replacement tanks 107b. A remaining amount sensor 107c is mounted in the W buffer tank 107a, and obtains the liquid remaining amount in the W buffer tank. In a case where the W buffer tank 107a has a free space of one W replacement tank 107b or more, the user replaces one of the W replacement tanks 107b with an unused W replacement tank 107b. All W liquid in the replacing unused W replacement tank 107b is supplied to the W buffer tank 107a. In this case, all W liquid includes the case where there is a residue in the W replacement tank 107b. Using up the W replacement tank 107b having no agitation unit just after the replacement prevents occurrence of separation and sedimentation of the W liquid in the W replacement tank 107b. Note that a liquid capacity of one W replacement tank is 20% of a volume of liquid storable in the W buffer tank. This value is merely an example, and may be other values. Moreover, the tank configuration of W is different from the tank configuration of C, M, Y, and K in that an agitation unit 107e is provided in the W buffer tank 107a and two W replacement tanks 107b are present. Although there are two W replacement tanks 107b in the present embodiment, this is merely an example. There may be three or more W replacement tanks 107b.

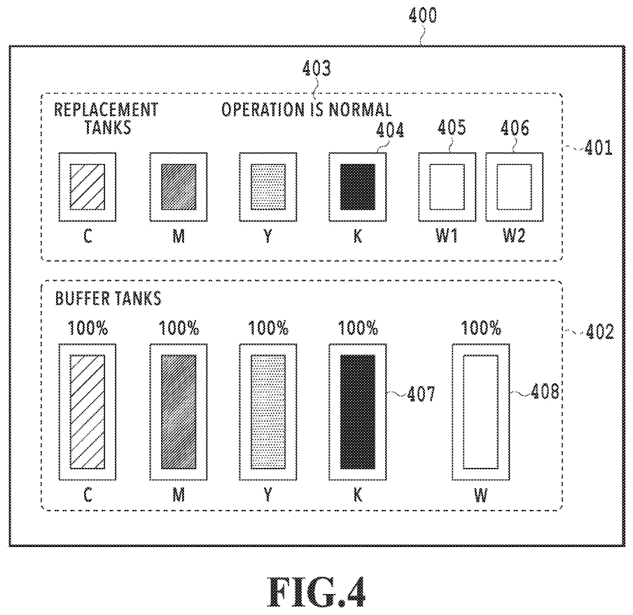

Since behaviors of C, M, Y, and K are the same, K is explained as a representative example hereinafter. FIG. 4 is a diagram illustrating a first state of display of the liquid remaining amounts on a UI. A liquid screen 400 is displayed on the operation display unit 203, and includes a replacement tank display region 401 and a buffer tank display region 402. The replacement tank display region 401 is a region displaying states of the replacement tanks, and includes a notification region 403 displaying an overall state, CMYK replacement tank state display portions 404 displaying states of the CMYK replacement tanks, and W replacement tank state display portions 405 and 406. The liquid remaining amounts are not displayed in the replacement tank state display portions 404, 405, and 406, and information indicating only whether replacement of the liquid tank is possible or not is displayed therein. The user identifies the liquid to be replaced by recognizing this information. The buffer tank display region 402 is a region displaying states of the buffer tanks, and includes CMYK buffer tank state display portions 407 displaying the states of the CMYK buffer tanks and a W buffer tank state display portion 408. The remaining amounts in the CMYK buffer tank state display portions 407 and the W buffer tank state display portion 408 are displayed by numerical values in percentage in upper portions of the display portions and changes in shapes of images.

The liquid screen 400 illustrated in FIG. 4 illustrates a state where the buffer tanks are full. The remaining amounts of the CMYK buffer tanks 108a and the W buffer tank 107a are 100%. The CMYK buffer tank state display portions 407 and the W buffer tank state display portion 408 are displayed in a similar manner. The liquids are left in the replacement tanks 108b, and there is no display prompting replacement in the CMYK replacement tank state display portions 404. Although no liquid is left in the W replacement tanks 107b, there is no display prompting replacement in the W replacement tank state display portions 405 and 406. This is because the W buffer tank 107a has no free space for the capacity of one W replacement tank 107b with no agitation unit. In a case where a free space for the capacity of one W replacement tank 107b is formed in the W buffer tank 107a and the W replacement tank 107b is replaced, all W liquid is supplied from the replacing W replacement tank 107b to the W buffer tank 107a. Using up the W replacement tank 107b with no agitation unit just after the replacement prevents occurrence of separation and sedimentation of the W liquid in the W replacement tank 107b. Accordingly, no display prompting replacement is given in the W replacement tank state display portion 405 or 406 until a free space for the capacity of one W replacement tank 107b is formed in the W buffer tank 107a. Thus, no message (no content) prompting replacement is displayed in the notification region 403.

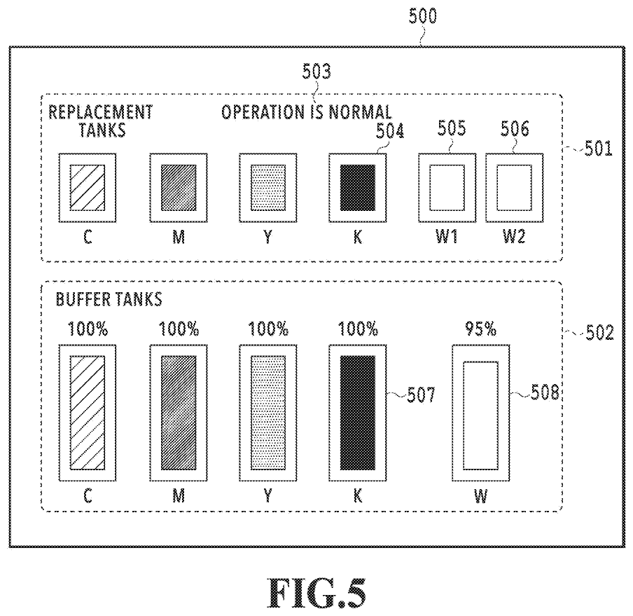

FIG. 5 is a diagram illustrating a second state of display of the liquid remaining amounts on the UI. A W buffer tank state display portion 508 in a liquid screen 500 is different from the above-mentioned W buffer tank state display portion 408 in the liquid screen 400 only in display of the liquid remaining amount. The liquid screen 500 illustrates a state where the K and W liquids are slightly consumed from those in the liquid screen 400. In a case of the K liquid, since the K liquid corresponding to the consumed liquid amount is supplied from the replacement tank 108b, the liquid remaining amount of the K buffer tank 108a remains to be 100%. Specifically, in the replacement tanks that are not the W replacement tanks, the liquids are gradually supplied from the replacement tanks to the buffer tanks. Display in a K buffer tank state display portion 507 is also 100%. The liquid is still left in the K replacement tank 108b, and no display prompting replacement is given in a K replacement tank state display portion 504. Meanwhile, in a case of the W liquid, since the W replacement tanks 107b are already empty, no liquid is supplied from the W replacement tanks 107b. Accordingly, the liquid remaining amount of the W buffer tank 107a has decreased to 95%. Display of the liquid remaining amount in the W buffer tank state display portion 508 is also 95%. No liquid is left in the W replacement tanks 107b. However, since the W buffer tank 107a has no free space for the capacity of one W replacement tank 107b, no display prompting replacement is given in the W replacement tank state display portions 505 and 506. Accordingly, no message prompting replacement is displayed in a notification region 503.

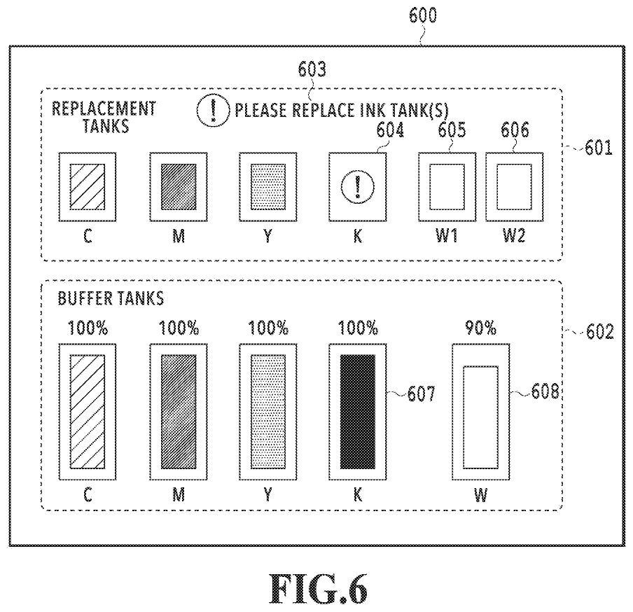

FIG. 6 is a diagram illustrating a third state of display of the liquid remaining amounts on the UI. A W buffer tank state display portion 608 in a liquid screen 600 is different from the above-mentioned W buffer tank state display portion 408 in the liquid screen 400 only in display of the liquid remaining amount. The liquid screen 600 illustrates a state where the K and W liquids are further consumed from those in the liquid screen 500 and the replacement of the K replacement tank 108b has become possible. Display of a K buffer tank state display portion 607 is 100% according to the liquid remaining amount of the K buffer tank 108a. Since the K replacement tank 108b is empty, display indicating that replacement is necessary is given in a K replacement tank state display portion 604. The liquid remaining amount of 90% is displayed in the W buffer tank state display portion 608 according to the liquid remaining amount of the W buffer tank 107a. No liquid is left in the W replacement tanks 107b. However, since the W buffer tank 107a has no free space for the capacity of one W replacement tank 107b, no display prompting replacement is given in W replacement tank state display portions 605 and 606. Display indicating that liquid replacement is necessary is given in a notification region 603. This display prompts the user to replace the K replacement tank 108b. In this case, the CPU of the control unit 202 may notify the user that the replacement of the replacement tank is necessary, through the audio unit 212.

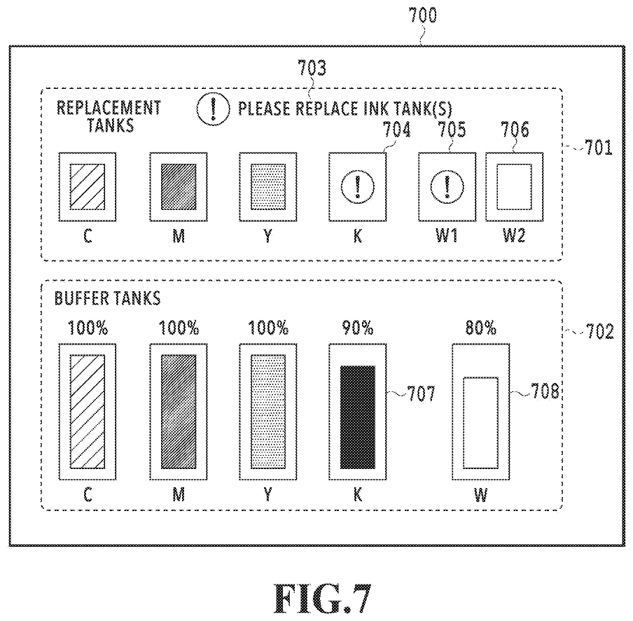

FIG. 7 is a diagram illustrating a fourth state of display of the liquid remaining amounts on the UI. A W buffer tank state display portion 708 in a liquid screen 700 is different from the above-mentioned W buffer tank state display portion 408 in the liquid screen 400 only in display of the liquid remaining amount. The liquid screen 700 illustrates a state where the K and W liquids are further consumed from those in the liquid screen 600 and the replacement of the W replacement tank 107b has become possible in addition to the K replacement tank 108b. The liquid remaining amount of 90% is displayed in a K buffer tank state display portion 707 as indicated by the remaining amount sensor 108c in the K buffer tank 108a. Since the K replacement tank 108b is empty, display indicating that replacement is necessary is given in a K replacement tank state display portion 704. The liquid remaining amount of 80% is displayed in the W buffer tank state display portion 708 according to the remaining amount of the W buffer tank 107a. Since the W buffer tank 107a has a free space for the capacity of one W replacement tank 107b, display prompting replacement is given in a W replacement tank state display portion 705, and no display prompting replacement is given in a W replacement tank state display portion 706. Display indicating that liquid replacement is necessary is given in a notification region 703. This display prompts the user to replace the K replacement tank 108b and one W replacement tank 107b. The W liquid requires agitation. Since the W buffer tank 107a only has a free space for the capacity of one W replacement tank 107b in the state illustrated in FIG. 7, replacement of only one W replacement tank is displayed in the UI screen. The CPU of the control unit 202 may notify the user that the replacement of the replacement tanks is necessary, through the audio unit 212.

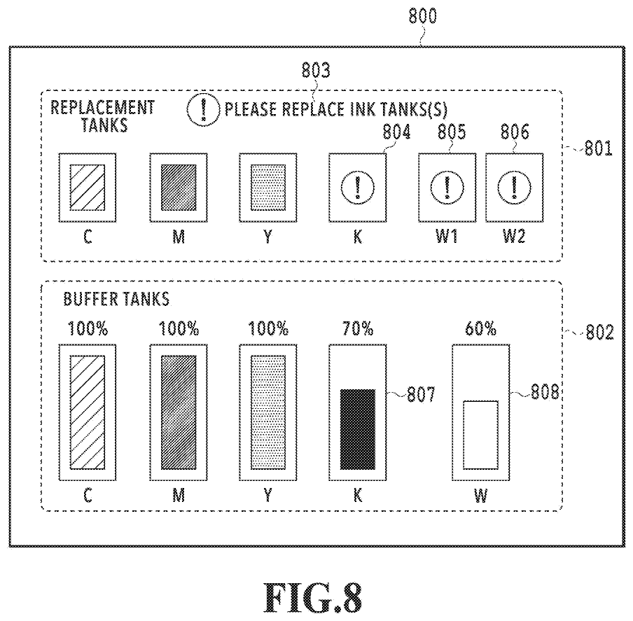

FIG. 8 is a diagram illustrating a fifth state of display of the liquid remaining amounts on the UI. A W buffer tank state display portion 808 in a liquid screen 800 is different from the above-mentioned W buffer tank state display portion 408 in the liquid screen 400 only in the display of the liquid remaining amount. The liquid screen 800 illustrates a state where the K and W liquids are further consumed from those in the liquid screen 700 and replacement of two W replacement tanks 107b has become possible in addition to the K replacement tank 108b. The liquid remaining amount of 70% is displayed in a K buffer tank state display portion 807 according to the liquid remaining amount of the K buffer tank 108a. Since the K replacement tank 108b is empty, display indicating that replacement is necessary is given in a K replacement tank state display portion 804. The liquid remaining amount of 60% is displayed in the W buffer tank state display portion 808 as indicated by the remaining amount sensor 108c in the W buffer tank 107a. Since the W buffer tank 107a has a free space for a capacity of two W replacement tanks 107b, display prompting replacement is given in W replacement tank state display portions 805 and 806. Display indicating that liquid replacement is necessary is given in a notification region 803. This display prompts the user to replace the K replacement tank 108b and two W replacement tanks 107b. The CPU of the control unit 202 may notify the user that the replacement of the replacement tanks is necessary, through the audio unit 212.

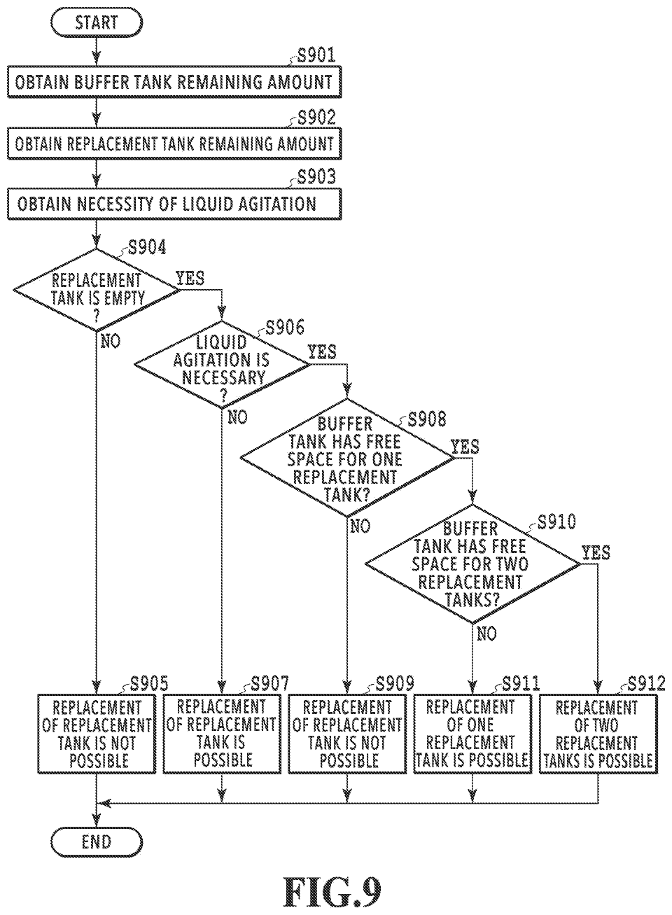

FIG. 9 is a flowchart illustrating control of liquid tank replacement notification. Processes of S901 and beyond are performed for each liquid color according to predetermined triggers to determine the liquid remaining amounts and to determine whether replacement of the replacement tank is necessary or not. Specifically, the processes of S901 and beyond are executed according to predetermined event triggers and periodic triggers. The event triggers are at activation of the printing apparatus system 100, at start of printing, at occurrence of an error, and at completion of replacement of the replacement tank. The event triggers may include a timing at which a screen for obtaining liquid information is displayed in the operation display unit 203. In the periodic triggers, processes are executed at intervals of 10 seconds during printing, and at intervals of 60 seconds during no-printing. In a situation where no printing is performed such as in occurrence of an error, periodic determination of liquid replacement notification may be stopped. These processes are executed mainly through the storage unit 201 and the operation display unit 203, based on instructions of the CPU of the control unit 202.

In S901, the CPU of the control unit 202 obtain the liquid remaining amount of each of the buffer tanks 107a and 108a from the remaining amount sensors 107c and 108c, and stores the obtained value in the storage unit 201, and the processing proceeds to S902. In S902, the CPU of the control unit 202 obtains the liquid remaining amount of each of the replacement tanks 107b and 108b from the remaining amount sensors 107d and 108d, and stores the obtained value in the storage unit 201, and the processing proceeds to S903. In S903, the CPU of the control unit 202 refers to information on necessity of liquid agitation stored in the storage unit 201, and obtains information that agitation is unnecessary for the K liquid and information that agitation is necessary for the W liquid, and the processing proceeds to S904.

In S904, the CPU of the control unit 202 determines whether the liquid remaining amount of each replacement tank obtained in S902 is empty or not. In a case where the replacement tank is empty, the processing proceeds to S906. In a case where the replacement tank is not empty, the processing proceeds to S905. In S905, the CPU of the control unit 202 determines that replacement of a corresponding one of the replacement tanks 107b and 108b is not possible, and the processing of the flowchart illustrated in FIG. 9 is terminated. The K liquid is in the state illustrated in the liquid screens 300 and 400. After the CPU of the control unit 202 determines that the replacement is not possible, the CPU of the control unit 202 does not unlock the lid for the corresponding replacement tank, and the user cannot replace the replacement tanks 107b and 108b.

In S906, the CPU of the control unit 202 determines whether the empty replacement tank is a replacement tank of a liquid for which liquid agitation is necessary, based on the information on the necessity of liquid agitation obtained in S903. In a case where the CPU of the control unit 202 determines that the empty replacement tank is a replacement tank of a liquid for which liquid agitation is necessary, the processing proceeds to S908. In a case where the CPU of the control unit 202 determines that the empty replacement tank is a replacement tank of a liquid for which liquid agitation is unnecessary, the processing proceeds to S907. In S907, the CPU of the control unit 202 determines that the replacement of the K replacement tank 108b is possible, and the processing of the flowchart illustrated in FIG. 9 is terminated. In this case, the K liquid is in the state illustrated in the liquid screens 600, 700, and 800. After the CPU of the control unit 202 determines that the replacement of the K replacement tank 108b is possible, the CPU of the control unit 202 unlocks the lid of the K replacement tank 108b, and the user replaces the K replacement tank with an unused K replacement tank. In a case where the user replaces the K replacement tank with the unused K replacement tank and then closes the lid, the CPU of the control unit 202 locks the lid again. Then, the CPU of the control unit 202 supplies the liquid from the unused K replacement tank 108b as necessary depending on the liquid remaining amount of the K buffer tank 108a. In a case where the CPU of the control unit 202 determines that the K replacement tank 108b is empty, the CPU unlocks the lid of the K replacement tank 108b. In a case where the K replacement tank 108b is empty but there is a sufficient amount of liquid in the K buffer tank 108a, the printing apparatus system 100 can perform printing. This is because an event posing trouble for printing does not occur in a case where there is a sufficient amount of liquid in the K buffer tank 108a.

In S908, the CPU of the control unit 202 determines whether the W buffer tank 107a has a free space for the capacity of one W replacement tank 107b. In the present embodiment, in a case where the liquid remaining amount of the W buffer tank 107a is equal to or less than 80%, the CPU of the control unit 202 determines that the W buffer tank 107a has a free space for the capacity of one W replacement tank 107b, and the processing proceeds to S910. In a case where the liquid remaining amount of the W buffer tank 107a is greater than 80%, the CPU of the control unit 202 determines that the W buffer tank 107a does not have a free space for the capacity of one W replacement tank 107b, and the processing proceeds to S909. In S909, the CPU of the control unit 202 determines that the replacement of the W replacement tank 107b is not possible, and the processing of the flowchart illustrated in FIG. 9 is terminated. The W liquid is in the state illustrated in the liquid screens 400, 500, and 600. After the CPU of the control unit 202 determines that the replacement is not possible, the CPU of the control unit 202 does not unlock the lids for the W replacement tanks 107b, and the user cannot replace the W replacement tanks 107b.

In S910, the CPU of the control unit 202 determines whether the W buffer tank 107a has a free space for the capacity of two W replacement tanks 107b. In the present embodiment, in a case where the liquid remaining amount of the W buffer tank 107a is equal to or less than 60%, the CPU of the control unit 202 determines that the W buffer tank 107a has a free space for the capacity of two W replacement tanks 107b, and the processing proceeds to S912. In a case where the liquid remaining amount of the W buffer tank 107a is greater than 60%, the CPU of the control unit 202 determines that the W buffer tank 107a has a free space for the capacity of one W replacement tank 107b, and the processing proceeds to S911.

In S911, the CPU of the control unit 202 determines that replacement of one W replacement tank 107b is possible, and the processing of the flowchart illustrated in FIG. 9 is terminated. The W liquid is in the state illustrated in the liquid screen 700, and the W replacement tank state display portion 705 displays that replacement is possible. In this case, the CPU of the control unit 202 may notify the user that replacement of the replacement tank is necessary, through the audio unit 212. There are two W replacement tanks 107b for the W liquid. The first W replacement tank 107b is the W replacement tank 107b corresponding to W1 (hereinafter, referred to as “W1 replacement tank”) illustrated in the W replacement tank state display portion 705. The second W replacement tank 107b is the W replacement tank 107b corresponding to W2 (hereinafter, referred to as “W2 replacement tank”) illustrated in the W replacement tank state display portion 706. After the CPU of the control unit 202 determines that the replacement is possible, the CPU of the control unit 202 unlocks the lid for the W1 replacement tank 107b, and does not unlock the lid for the W2 replacement tank 107b. Since the W liquid requires agitation, the user needs to perform agitation by manually shaking the W replacement tank in the setting of the W replacement tank. The user takes out the empty W1 replacement tank for which the lid is unlocked, replaces it with the unused W replacement tank just after agitation, and closes the lid. Then, the CPU of the control unit 202 locks the lid again. Next, the CPU of the control unit 202 supplies the W liquid from the unused W1 replacement tank 107b to the W buffer tank 107a. Since the W buffer tank 107a has a free space capable of receiving the capacity of one W1 replacement tank 107b, all W liquid in the unused W1 replacement tank 107b is supplied to the buffer tank 107a. As a result, the W1 replacement tank 107b becomes empty again. However, the CPU of the control unit 202 executes control of not performing the notification prompting replacement as illustrated in the liquid screens 400 and 500.

In S912, the CPU of the control unit 202 determines that replacement of both W replacement tanks 107b is possible, and the processing of the flowchart illustrated in FIG. 9 is terminated. The W liquid is in the state illustrated in the liquid screen 800. The above-mentioned event occurs due to the following reason. Since the printing apparatus system 100 can perform printing even in a case where the W buffer tank 107a has a free space for the capacity of one W replacement tank 107b, the liquid remaining amount of the W buffer tank 107a gradually decreases. Since the liquid remaining amount of the W buffer tank 107a is periodically checked, the liquid remaining amount of the W buffer tank 107a gradually decreases from 75% to 65%, and to 55%. Accordingly, if there is no replenishment of the W replacement tank 107b, the W buffer tank 107a will have a free space for the capacity of two W replacement tanks 107b.

After the CPU of the control unit 202 determines that replacement of two W replacement tanks 107b is possible, the CPU of the control unit 202 unlocks the lids for both W replacement tanks 107b. The user takes out the two empty W replacement tanks 107b for which the lids are unlocked, replaces them with the unused W replacement tanks 107b subjected to agitation by being manually shaken, and closes the lids. Then, the CPU of the control unit 202 locks the lids again. Since the W buffer tank 107a has a free space capable of receiving the capacity of two W replacement tanks 107b, all W liquid in the two unused W replacement tanks 107b is supplied to the W buffer tank 107a. As a result, the two W replacement tanks 107b become empty again. However, the CPU of the control unit 202 executes control of not performing the notification prompting replacement as illustrated in the liquid screens 400 and 500.

As explained above, according to the present embodiment, it is possible to notify the user of replacement of the replacement tank at an appropriate timing. Thereby, the liquid can swiftly be supplied from the unused replacement tank to the buffer tank.

### Second Embodiment

In the first embodiment, in S911, the CPU of the control unit 202 sets the W replacement tank state display portion 705, that is the W1 replacement tank 107b as the replacement target in the liquid screen 700 illustrated in FIG. 7. However, the present disclosure is not limited to this. Specifically, the configuration may be such that the W1 replacement tank 107b and the W2 replacement tank 107b are alternately replaced. Alternately replacing the replacement tanks can equalize damages to related units such as opening and closing of the lids operated in the replacement. Details of the present embodiment are explained below. Note that, although explanation is given assuming that there are two replacement tanks of W liquid in the present embodiment, this is merely an example. The number of replacement tanks of W liquid may be three or more.

In the following explanation, differences from the first embodiment are explained. First, in a case where the CPU of the control unit 202 locks the lid for the W replacement tank, the CPU of the control unit 202 stores information indicating one of the W1 replacement tank 107b and the W2 replacement tank 107b whose lid has been locked, in the storage unit 201 as latest replacement tank information. An initial value of the latest replacement tank information is assumed to be the W2 replacement tank 107b. In the next replacement of the W replacement tank 107b, the CPU of the control unit 202 gives the user an instruction to first replace the W replacement tank 107b that is not the latest replacement tank information.

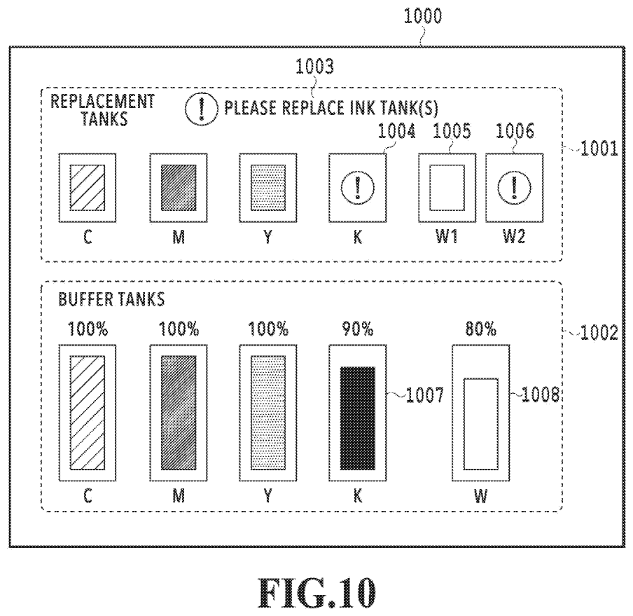

FIG. 10 is a diagram illustrating a sixth state of display of the liquid remaining amounts on the UI. A liquid screen 1000 is different from the above-mentioned liquid screen 700 only in states of W replacement tank state display portions 1005 and 1006. In the liquid screen 1000, there is no display prompting replacement in the W replacement tank state display portion 1005. Display prompting replacement is displayed in the W replacement tank state display portion 1006. Display indicating that liquid replacement is necessary is given in a notification region 1003. In this case, the CPU of the control unit 202 may notify the user that the replacement of the replacement tank is necessary, through the audio unit 212.

Next, in S911, the CPU of the control unit 202 determines that replacement of one W replacement tank 107b is possible, and obtains information on the latest-replaced W replacement tank 107b from the storage unit 201. In a case where the obtained result of the latest-replaced W replacement tank is the W2 replacement tank 107b, the CPU of the control unit 202 determines that replacement of the W1 replacement tank 107b is possible. This is the same as the state illustrated in the liquid screen 700 of FIG. 7 in the first embodiment. In the present embodiment, the obtained result of the latest-replaced W replacement tank is the W1 replacement tank 107b. Accordingly, the CPU of the control unit 202 determines that replacement of the W2 replacement tank 107b is possible, and the processing of the flowchart illustrated in FIG. 9 is terminated. Specifically, the printing apparatus system 100 is in the state illustrated in the liquid screen 1000.

After the CPU of the control unit 202 determines that replacement of the W2 replacement tank 107b is possible, the CPU of the control unit 202 unlocks the lid for the W2 replacement tank 107b, and does not unlock the lid for the W1 replacement tank 107b. Since agitation is necessary for the W liquid, the user needs to perform agitation by manually shaking the W replacement tank. The user takes out the empty W2 replacement tank for which the lid is unlocked, replaces it with the unused W replacement tank just after agitation, and closes the lid. Then, the CPU of the control unit 202 locks the lid again. The CPU of the control unit 202 identifies that the locked lid is the lid for the W2 replacement tank 107b, rewrites the latest replacement tank information in the storage unit 201 to the W2 replacement tank 107b, and stores the rewritten latest replacement tank information. In the next replacement of one W replacement tank 107b, the replacement of the W1 replacement tank 107b becomes possible. Specifically, the printing apparatus system 100 is in the state illustrated in the liquid screen 700.

Then, the CPU of the control unit 202 supplies the W liquid from the unused W2 replacement tank 107b to the W buffer tank 107a. Since the W buffer tank 107a has a free space capable of receiving the capacity of one W2 replacement tank 107b in this case, all liquid in the unused W2 replacement tank is supplied to the W buffer tank 107a. As a result, the W2 replacement tank 107b becomes empty again. However, the CPU of the control unit 202 executes control of not performing the notification prompting replacement as illustrated in the liquid screens 400 and 500.

In S912, the CPU of the control unit 202 determines that replacement of both W replacement tanks 107b is possible, and the processing of the flowchart illustrated in FIG. 9 is terminated. The W liquid is in the state illustrated in the liquid screen 800. After the CPU of the control unit 202 determines that replacement of both W replacement tanks 107b is possible, the CPU of the control unit 202 unlocks the lids for both W replacement tanks 107b. The user takes out the two empty W replacement tanks 107b for which the lids are unlocked, replaces them with two unused W replacement tanks 107b subjected to agitation by being manually shaken, and closes the lids. Then, the CPU of the control unit 202 locks the lids again. Every time the lid is locked, the CPU of the control unit 202 identifies the locked lid, rewrites the latest replacement tank information in the storage unit 201 to the W replacement tank 107b for which the lid is locked, and stores the rewritten latest replacement tank information. Since the W buffer tank 107a has a free space capable of receiving the capacity of two W replacement tanks 107b in this case, all W liquid in the two unused W replacement tanks 107b is supplied to the W buffer tank 107a. As a result, the two W replacement tanks 107b become empty again. However, the control unit 202 executes control of not performing the notification prompting replacement as illustrated in the liquid screens 400 and 500.

In a case where the CPU of the control unit 202 determines that replacement of both W replacement tanks 107b is possible, the CPU of the control unit 202 unlocks the lids of both W replacement tanks 107b. As an alternative method, the CPU of the control unit 202 does not have to rewrite the latest replacement tank information in the storage unit 201. The user takes out the two empty W replacement tanks 107b for which the lids are unlocked, replaces them with two W replacement tanks 107b subjected to agitation by being manually shaken, and closes the lids. Accordingly, the latest replacement tank information does not have to be rewritten. The damage to the related units such as opening and closing of the lids can be thereby equalized. In a case where there are three or more W replacement tanks 107b, plural W replacement tanks 107b are sequentially used by using information indicating the W replacement tank 107b to be used next instead of the latest replacement tank information. In a case where the W buffer tank 107a has a free space for plural W replacement tanks 107b, information that replacement of plural W replacement tanks 107b is possible is displayed in the UI operation panel 102, and the user can replace the plural W replacement tanks 107b with unused W replacement tanks.

As explained above, according to the present embodiment, it is possible to notify the user of replacement of the replacement tank at an appropriate timing. Moreover, regarding the liquid for which there are plural replacement tanks and that requires agitation, the information on the latest-replaced replacement tank is stored to enable equalization of damages to related units.

### Third Embodiment

In the first embodiment, the information on the necessity of liquid agitation that is obtained by the CPU of the control unit 202 from the storage unit 201 in S906 is explained as a fixed value. However, the configuration may be such that this information is changed depending on conditions. Specifically, in a case where a W liquid in which separation and sedimentation is less likely to occur among the variations of W liquid is used, the CPU of the control unit 202 may update the information on the necessity of liquid agitation via the operation display unit 203, and change this W liquid to the liquid for which agitation is unnecessary. In a case where agitation is unnecessary for the W liquid, the W liquid is subject to replacement work of the replacement tank similar to that for the liquids of CMYK. In a case where agitation is necessary for the W liquid, the W liquid is subjected to the same replacement work of the replacement tank as that in the first embodiment. Accordingly, it is possible to notify the user of the replacement of the replacement tank at an appropriate timing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-089957, filed May 31, 2023, which is hereby incorporated by reference wherein in its entirety.

What is claimed is:

1. A controlling apparatus which includes a buffer tank configured to supply a liquid, which contains a sedimentation component, to a print head device and a replacement tank configured to supply the liquid to the buffer tank, and is configured to control a printing apparatus capable of performing printing by using the liquid, comprising:
one or more processors and/or circuitry which function as:
an obtaining unit configured to obtain liquid remaining amounts of the replacement tank of the liquid and the buffer tank of the liquid; and
a notification unit configured to notify content that replacement of the replacement tank is possible in a case where the replacement tank of the liquid is empty and the buffer tank of the liquid has a free space equal to one replacement tank of the liquid or more.

2. The controlling apparatus according to claim 1, wherein
the one or more processors and/or circuitry further function as a control unit configured to determine that replacement of the replacement tank is possible in a case where the replacement tank of the liquid is empty and the buffer tank of the liquid has a free space equal to one replacement tank of the liquid or more, and
the notification unit notifies content that replacement of the replacement tank is possible in a case where the control unit determines that replacement is possible.

3. The controlling apparatus according to claim 1, wherein
the printing apparatus includes a replacement tank in which a predetermined liquid is gradually supplied from a predetermined replacement tank to a predetermined buffer tank and a replacement tank in which all liquid in the replacement tank is supplied to the buffer tank in case of replacing the replacement tank.

4. The controlling apparatus according to claim 3, wherein the predetermined liquid is a liquid not containing the sedimentation component.

5. The controlling apparatus according to claim 1, wherein the printing apparatus includes a plurality of the replacement tanks of the liquid.

6. The controlling apparatus according to claim 5, wherein, in a case where the buffer tank of the liquid has a free space for the plurality of replacement tanks of the liquid, the notification unit notifies content that replacement of the plurality of the replacement tanks of the liquid is possible.

7. The controlling apparatus according to claim 1, wherein the notification unit displays notification content on a UI screen.

8. The controlling apparatus according to claim 1, wherein the notification unit notifies notification content through audio.

9. The controlling apparatus according to claim 2, wherein, in a case where a replacement tank of a liquid not containing the sedimentation component is empty, the control unit determines that replacement of the replacement tank of the liquid not containing the sedimentation component is possible.

10. The controlling apparatus according to claim 2, wherein, the control unit locks the replacement tank of the liquid in a case where the replacement of the replacement tank of the liquid is not possible, and unlocks the replacement tank of the liquid in a case where the replacement of the replacement tank of the liquid is possible.

11. A method of controlling a controlling apparatus which includes a buffer tank configured to supply a liquid, which contains a sedimentation component, to a print head device and a replacement tank configured to supply the liquid to the buffer tank, and is configured to control a printing apparatus capable of performing printing by using the liquid, the method comprising:
obtaining liquid remaining amounts of the replacement tank of the liquid and the buffer tank of the liquid; and
notifying content that replacement of the replacement tank is possible in a case where the replacement tank of the liquid is empty and the buffer tank of the liquid has a free space equal to one replacement tank of the liquid or more.

12. A non-transitory computer readable storage medium storing a program for causing a computer to perform a method of controlling a controlling apparatus which includes a buffer tank configured to supply a liquid, which contains a sedimentation component, to a print head device and a replacement tank configured to supply the liquid to the buffer tank, and is configured to control a printing apparatus capable of performing printing by using the liquid, the method comprising:
obtaining liquid remaining amounts of the replacement tank of the liquid and the buffer tank of the liquid; and
notifying content that replacement of the replacement tank is possible in a case where the replacement tank of the liquid is empty and the buffer tank of the liquid has a free space equal to one replacement tank of the liquid or more.
